(19) United States
(12) Patent Application Publication
(10) Pub. No.: US 2008/0282889 A1
(43) Pub. Date: Nov. 20, 2008

(54) OIL SHALE BASED METHOD AND APPARATUS FOR EMISSION REDUCTION IN GAS STREAMS

(75) Inventors: Richard D. Boardman, Idaho Falls, ID (US); Robert A. Carrington, Idaho Falls, ID (US); Jason C. Stolworthy, Idaho Falls, ID (US)

Correspondence Address: BATTELLE ENERGY ALLIANCE, LLC, P.O. BOX 1625, IDAHO FALLS, ID, 83415-3899, US

(73) Assignee: Battelle Energy Alliance, LLC, Idaho Falls, ID (US)

(21) Appl. No.: 11/749,788

(22) Filed: May 17, 2007

(51) Int. Cl. B01D 53/02; B01D 53/48; B01D 53/50; B01D 53/52; B01D 53/54; B01D 53/56; B01D 53/64; B01D 53/70

(52) U.S. Cl. 95/129; 422/288; 95/128; 95/131; 95/132; 95/133; 95/134; 95/135; 95/136; 95/137; 95/90

(57) ABSTRACT

Pollution reduction processes may be incorporated with, or retrofit to fit with, existing combustion processes to assist with the reduction of pollutants produced in the combustion process. The thermal treatment of oil shale in the pollution reduction process produces kerogen, shale sorbent particles, or mixtures thereof, which may be reacted with a pollutant-containing gas or pollutant-containing gas having particulate matter entrained therein to reduce the pollutants in the gas. Apparatuses employing the processes are also disclosed.

### STATEMENT REGARDING FEDERALLY SPONSORED RESEARCH OR DEVELOPMENT

The United States Government has certain rights in this invention pursuant to Contract No. DE-AC07-05-ID14517 between the United States Department of Energy and Battelle Energy Alliance, LLC.

### FIELD OF THE INVENTION

The invention relates to methods and apparatuses for reducing pollutants, especially pollutants from combustion or gasification processes. More particularly, oil shale and oil shale products are used as sorbents or reductants for reducing pollutants from industrial processes by absorption, adsorption, and reduction of the pollutants.

### BACKGROUND

Coal, oil, natural gas, oil shale, oil sands, and other carbon-containing fuel feedstock materials (for example: forestry industry products, byproducts, and residues; agriculture crops, byproducts, and residues; animal wastes and carcasses; municipal solid waste, sewage sludge solids, construction and demolition debris, waste tires, and other forms of refuse-derived fuel) are converted from chemical potential energy to heat and gaseous products that are used to generate electrical power, or to produce higher value chemicals and components. Thermal conversion (combustion or gasification) of such gaseous and solid materials produces various pollutants, such as nitrogen compounds or sulfur compounds, which are believed to be involved in the formation of smog and acid rain. If the fuel includes mercury, the combustion also produces mercury compounds, which have been identified by the Environmental Protection Agency (EPA) as a significant toxic pollutant.

Air pollutant control legislation, such as the Clean Air Act (CAA), the Clean Air Interstate Regulation (CAIR), and the Clean Air Mercury Regulation (CAMR), regulate emissions of many of the pollutants released from thermal conversion processes, which include processes that liberate or transform the chemical potential energy of a fuel into heat, hot gases, combustible gases, combustible liquids, combustible solids such as char, and non-combustible solids such as ash or calcined minerals, or any subset of these. Recent legislation and prospects for additional pollution-reduction legislation threaten to require broad changes for conventional thermal conversion power plants in order to achieve the reduced pollutant levels required. The changes require retrofitting of conventional thermal conversion power plants to achieve the pollution and emission goals.

Some of the pollutants targeted for reduction by recent legislation include oxides of nitrogen (NOₓ) emissions, sulfur oxide (SOₓ) emissions, and mercury (Hg) pollutants. Current methods for retrofitting thermal conversion power plants to reduce such emissions require separate retrofits for each of the various pollutants being reduced. For example, a convention coal-fired power plant may require an NOₓ pollutant reduction retrofit as well as an SOX pollutant reduction retrofit. Purchasing and installing multiple pieces of equipment to reduce individual pollutants is expensive. In those instances where multi-pollutant control is feasible, the multi-pollutant control equipment and processes typically require significant re-design of the power plant. Each pollution reduction solution adds significant costs to thermal conversion power plant operations.

An example of a conventional energy production facility employing a thermal conversion process is illustrated in FIG. 1. An apparatus for effecting a combustion or other energy production process designated as facility 100 includes a boiler 110, an economizer 120, a precipitator/baghouse 130, a scrubber 140 and a stack 150. The boiler 110, for example, may be a pulverized coal combustion boiler 110 having a burner 104 for combusting coal 102 fed to the boiler 110. Air 108 is introduced to the boiler 110 for the combustion of the coal 102. A bottom ash 106 product exits the boiler 110 and gases produced from the combustion of coal 102 in the boiler 110 are passed to the economizer 120. Pipes 122 configured in the boiler 110 and economizer 120 heat up water 124 running through the pipes 122 to form steam 126 which is used in the generation of electricity, power by the energy production facility 100, or other process. Gases and particulate matter from the boiler 110 and economizer 120 are fed to a precipitator/baghouse 130 to collect and separate particulate matter and fly ash 132 from the gases, which are then fed to a scrubber 140. The scrubber 140 is used to remove pollutants from the gases passing through the scrubber 140. The scrubbed gases are then passed to a stack 150 where additional pollutants may be removed from the gases before the gases are released into the atmosphere.

The composition of various pollutant species produced by thermal conversion processes, such as the combustion or other energy production process of facility 100, is a function of the availability of oxygen in the process. Under the reducing conditions of pyrolysis and gasification, sulfur bound in the fuel is typically converted to reduced forms of sulfur, such as hydrogen sulfide, carbonyl sulfide, and carbon disulfide. Nitrogen contained in the fuel is converted to reduced nitrogen compounds, including ammonia, hydrogen cyanide, and molecular nitrogen. Most of the mercury in a fuel is converted to volatile elemental mercury (Hg°) and speciated mercury, such as mercury chloride (HgCl₂). Under reducing conditions, phosphorus (P) reacts with metals to form phosphate compounds, and may also be converted to phosphine (PH₃), phosphonium compounds, and other reduced forms of phosphorus. Chlorine (Cl) reacts with alkali metals (such as sodium and potassium), alkali-earth metals (such as calcium and magnesium), and other metals (such as mercury, zinc, and iron), but it is also converted to diatomic chlorine gas (Cl₂) and hydrochloric acid gas (HCl). Fluorine, bromine, and iodine behave similar to chlorine.

Under the oxidizing conditions of combustion, sulfur bound in fuel burned in a thermal conversion process is converted to gaseous sulfur dioxide or sulfur trioxide. Below the dew point, these sulfur compounds quickly equilibrate with moisture (H₂O) to form sulfur based acids, such as sulfuric acid (H₂SO₄) and sulfurous acid (H₂SO₃). Nitrogen bound in the fuel is converted to nitric oxide and nitrogen dioxide. Combustion with air also results in nitrogen oxides as a result of high temperature reactions of atomic oxygen (O) and hydroxide radicals with molecular nitrogen. Phosphorus, chlorine, fluorine, bromine, and iodine are readily converted to phosphoric acid (H₃PO₄), hydrochloric acid (HCl), hydrofluoric acid (HF), bromous acid (HBrO), and iodic acid (HIO₃), as well as other reactive volatile compounds. These acid gases are corrosive to equipment used in combustion processes, such as in a combustion device or in boiler tubes in a combustor. Therefore, it is desirable to limit the formation of the acid gases or to remove the acid gases close to their point of generation in a combustion device.

Conventional combustion processes, such as those employed in power plants, produce many, if not all, of such pollutant species during the thermal conversion of coal or other fuels to energy. Release of such pollutants into the atmosphere as off-gases or into the environment as sludge residue is unwanted.

To remove, for example, sulfur from the flue gases of the production facility 100 and NOₓ and SOₓ emissions, equipment for a flue gas desulphurization (FGD) process can be installed for SOX reduction along with that for a selective catalytic reduction (SCR) process for NOₓ reduction. Such equipment is expensive to install and maintain, and the processes require continuous monitoring and tuning to combustion conditions. If mercury reduction is also desired, additional feedstock to perform the required processes may need to be incorporated into the combustion or energy production process facility 100. For example, sorbents capable of absorbing or adsorbing mercury pollutants may be introduced upstream of the precipitator/baghouse 130 in an attempt to capture the mercury pollutants.

In further attempts to reduce pollutants, various technologies have been developed to decrease emissions from combustion processes, such as from those of coal-fired power plants. Limestone has been used as a sorbent for SOₓ pollutants, as disclosed in U.S. Pat. No. 3,995,006 to Downs et al., U.S. Pat. No. 5,176,088 to Amrhein et al., and U.S. Pat. No. 6,143,263 to Johnson et al. This technology is known as limestone injection multiple burner (LIMB) technology or limestone injection dry scrubbing (LIDS) technology. The limestone is injected into a region of a furnace having a temperature of 2,000° F. to 2,400° F.

Limestone, mainly calcium carbonate (CaCO₃), dolomite (CaCO₃—MgCO₃), and their derivatives have also been shown to react with hydrogen sulfide (H₂S). Uncalcined limestone or dolomite, half-calcined limestone or dolomite, fully calcined limestone or dolomite, lime, or hydrated lime (CaOH) react with hydrogen sulfide to form calcium sulfide (CaS) or magnesium sulfide (MgS). Such a reaction removes the polluting hydrogen sulfide.

Organic and amine reducing agents, such as ammonia or urea, are used to selectively reduce NOₓ pollutants, as disclosed in U.S. Pat. No. 3,900,554 to Lyon. This technique is known as selective noncatalytic reduction (SNCR). The reducing agent is injected into a furnace at a temperature from about 975 K to about 1375 K so that a noncatalytic reaction selectively reduces the NOₓ to molecular nitrogen (N₂). The ammonia is injected into a region of the furnace having a temperature of 1600° F. to 2000° F.

The LIMB and SNCR technologies have also been combined to simultaneously remove NOₓ pollutants and SOₓ pollutants from various processes. The limestone is used to reduce SOₓ pollutants while ammonia is used to absorb NOₓ pollutants. However, this combination of technology is expensive to implement and adds increased complexity to a process employing such pollution reducing measures.

Reburning has also been used to remove the NOₓ pollutants, as disclosed in U.S. Pat. No. 5,139,755 to Seeker et al. During NOₓ reburning, the coal is combusted in two stages. In the first stage, a portion of the coal is combusted with a normal amount of air (about 10% excess), producing the NOₓ pollutants. In the second stage, the remaining portion of the coal is combusted in a fuel-rich environment. Hydrocarbon radicals formed by combustion of the coal react with the NOₓ pollutants to form molecular nitrogen. Fuel/air staging has also been used to reduce the NOₓ pollutants. Fuel and air are alternately injected into a combustor to provide a reducing zone where the nitrogen in the fuel is evolved, which promotes the conversion of the nitrogen to molecular nitrogen. The air is injected at a separate location to combust the fuel volatiles and char particles. By staging or alternating the fuel and the air, the local temperature and the mixture of air and fuel are controlled to suppress the formation of NOₓ pollutants. Fuel/air staging attempts to prevent NOₓ formation while NOₓ reburning promotes NOₓ reduction and destruction.

To absorb mercury or mercury-containing pollutants produced in industrial processes, activated carbon is used as a sorbent, as disclosed in U.S. Pat. No. 5,827,352 to Altman et al. and 6,712,878 to Chang et al. The activated carbon is present as a fixed or fluidized-bed or is injected into the flue gas.

Oil shale has also been used to absorb SO₂ and HCl in a circulating fluidized-bed, as disclosed in “Combustion of Municipal Solid Wastes with Oil Shale in a Circulating Fluidized-bed,” Department of Energy Grant No. DE-FG01-94CE15612, Jun. 6, 1996, Energy-Related Inventions Program Recommendation Number 612, Inventor R. L. Clayson, NIST Evaluator H. Robb, Consultant J. E. Sinor and in “Niche Market Assessment for a Small-Scale Western Oil Shale Project,” J. E. Sinor, Report No. DOE/MC/11076-2759.

Many industrial processes, and in particular many of the pulverized coal combustors in operation, do not meet the new emissions and pollution standards promulgated by the United States Environmental Protection Agency under CAIR and CAMR. Upwards of about 75 percent of all currently existing pulverized coal combustors may have to be phased out, retrofitted, or modified to satisfy the new pollutant standards.

Conventional gasification processes that produce syngas utilize coal, biomass residuals, and solid waste or refuse derived fuel as fuels. Gasification of these fuels produces sulfur-, mercury-, chloride-, and nitrogen-containing pollutants. To reduce acid gas emissions produced by the gasification processes, amine scrubbers, recisol/selexol, and potassium carbonate scrubbers have been utilized. Absorption of the pollutants with these scrubbers or recisol/selexol occurs at relatively low temperatures, which necessitates cooling the syngas before exposure to the scrubbers or recisol/selexol. After removing the pollutants, the syngas is reheated for further processing, which adds inefficiencies and complexity to the gasification process. To reduce the mercury- and chloride-containing pollutants, activated carbon has been used as a sorbent. Removal of the mercury- and chloride-containing pollutants requires a separate reactor, which adds inefficiencies and complexity to the gasification process.

Therefore, it is desirable to develop new processes, methods, and apparatuses for producing cleaner thermal conversion processes and especially utilizing fuels such as coal, oil, gas, synthetic fuels, biomass, or other fuel sources. Methods, processes, and apparatuses for reducing or eliminating pollutant wastes from thermal conversion processes are also desired.

### SUMMARY OF THE INVENTION

In one embodiment, the present invention comprises a method for removing at least one pollutant from a pollutant-containing gas. The method comprises thermally treating oil shale in the presence of a pollutant-containing gas.

In another embodiment, the present invention comprises an apparatus for removing at least one pollutant from at least one gas. The apparatus comprises a reactor comprising at least one gas input, at least one gas output, and a thermal treatment zone configured for thermally treating oil shale in the presence of at least one gas fed to the thermal treatment zone to remove at least one pollutant from the at least one gas.

In another embodiment, the present invention comprises a method for removing at least one pollutant from syngas. The method comprises producing a first syngas from a fuel gasification process and a second syngas, kerogen, and shale sorbent particles from an oil shale gasification process. The first syngas and the second syngas is maintained at a temperature between about 500° C. and 1000° C. while exposing the first syngas and the second syngas to the kerogen and the shale sorbent particles. A temperature of the first syngas and the second syngas is reduced to less than or equal to about 200° C. while exposing the first syngas and the second syngas to the kerogen and the shale sorbent particles.

### BRIEF DESCRIPTION OF THE DRAWINGS

While the specification concludes with claims particularly pointing out and distinctly claiming that which is regarded as the present invention, this invention can be more readily understood and appreciated by one of ordinary skill in the art from the following description of the invention when read in conjunction with the accompanying drawings in which:

FIG. 1 illustrates a simplified schematic diagram of a conventional energy production facility;

FIG. 2 illustrates an energy production facility configured to implement pollution reduction process according to embodiments of the invention;

FIGS. 3 and 4 schematically illustrate shale sorbent particle production processes according to embodiments of the invention;

FIG. 5 illustrates an energy production facility configured to implement pollution reduction process according to embodiments of the invention;

FIG. 6 illustrates a pollution reduction process according to embodiments of the invention;

FIGS. 7-10 illustrate pollution reduction processes according to embodiments of the invention;

FIG. 11 illustrates a process flow diagram according to embodiments of the invention; and

FIG. 12 illustrates a pollution reduction process according to embodiments of the invention.

### DETAILED DESCRIPTION

According to particular embodiments of the invention, at least one gas, or at least one gas including entrained particulate matter, may be fed to one or more reactors or other vessels to effect pollution reduction processes that thermally treat oil shale or a combination of oil shale and other materials to reduce or remove pollutants present in the gases and in any particulates entrained therein. As used herein, the term “thermally treat” or grammatical equivalents thereof means and includes combusting, gasifying, retorting, pyrolyzing, or otherwise heating the oil shale or the combination of oil shale and other materials. Additional sources of heat for thermally treating the oil shale include electric heat or heat provided by the pollutant-containing gas. While the oil shale or the combination of oil shale and other materials is described herein as being combusted or gasified, other methods of providing energy in the form of heat to produce the shale sorbent particles may be used. Pollutants in the gases or gases and particulate matter may react or combine with the oil shale undergoing thermal treatment within the pollution reduction process or with products of the thermal treatment of oil shale, such as kerogen and shale sorbent particles. The particulates in the polluted gas may react with the shale sorbent particles or be absorbed, adsorbed, or otherwise captured by the shale sorbent particles. The reaction of the pollutants with the oil shale undergoing thermal treatment, kerogen, or shale sorbent particles reduces the overall pollution load in the gases or in the gases and particulate matter. The gases having reduced pollutants may be recycled or introduced back into the combustion process.

The oil shale may be thermally treated to produce shale sorbent particles, which are used to remove the pollutants from the gases or from particulates carried by the gases. The pollutants may also react with kerogen released from the oil shale or with hydrocarbon gases or syngas, reducing or eliminating the pollutants in the gas or in particulates in the gas.

Thermally treating the oil shale or a combination of the oil shale and other materials within the pollution reaction process, such as in one or more reactors, may facilitate the reduction of pollutants in the gas or in particulates carried by the gas which are fed to the pollution reaction process. While various embodiments of the invention are described with respect to the introduction of gases produced in a combustion process to one or more reactors, the gases may include particulate matter entrained therein. The reduction of pollutants in the gases according to embodiments of the invention may, therefore, also include the reduction of pollutants in particulate matter entrained in the gases. The pollutants in the gases or in particulates carried by the gases may be reduced or eliminated by exposing the pollutants in the gases or in particulates carried by the gases to the thermally treated oil shale or to oil shale undergoing thermal treatment.

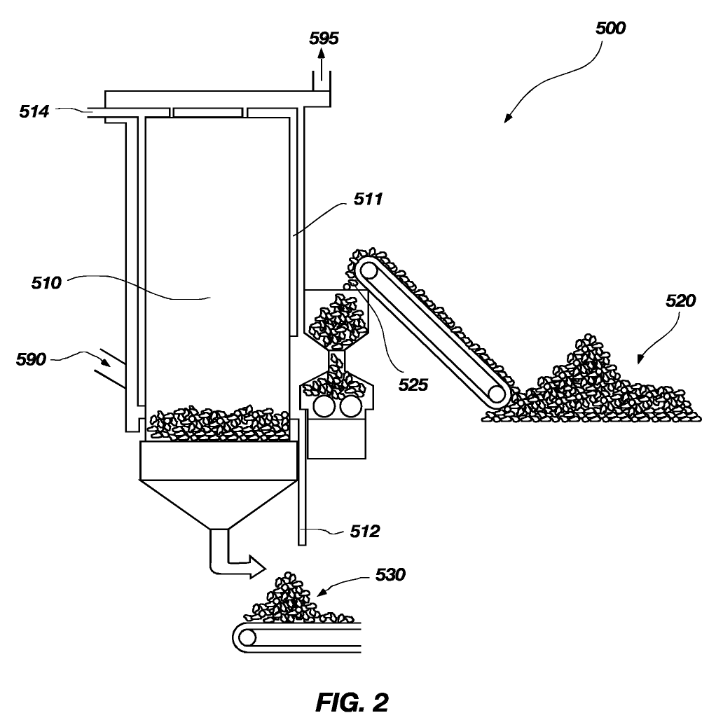

An example of a pollutant reaction process facility 500 according to particular embodiments of the invention is illustrated in FIG. 2. The pollutant reaction process facility 500 illustrated in FIG. 2 includes a reactor 510 which may include any type of conventional fluidized-bed reactor such as an atmospheric fluidized-bed reactor, a pressurized fluidized-bed reactor, an advanced circulating pressurized fluidized-bed reactor, or a modified pressurized fluidized-bed reactor. The reactor 510 may include a plurality of reactors 510 connected in series or parallel. The reactor 510 may include an economizer for heat transfer, such as one or more water inputs 512 connected to one or more water outputs 514 or steam outputs. Water introduced through a water input 512 into the reactor 510 may pass through pipes 511 therein or pipes 511 acting as a water membrane wall. Water introduced through the water inputs 512 may be heated by combustion processes occurring within the reactor 510. The heated water, in the form of hot water or steam, is released through the water outputs 514. The heated water or steam may couple with other processes to economize the use of heat in another unit operation or overall process.

While particular embodiments of the invention are described and illustrated with respect to the use of a fluidized-bed reactor as part of the pollutant reaction process facility 500 to accomplish reductions in pollutant emissions, other reactors or gasification units may be substituted for or used in place of, or in combination with, one or more reactors 510 to achieve the desired pollutant reduction. For example, other reactors that may be used in place of or in combination with the reactor 510 according to embodiments of the invention include, but are not limited to, a furnace, a combustion chamber, a circulating-bed combustion chamber, a staged reactor combustion chamber, an entrained-flow combustion chamber, a boiler, a reactor, a retort, a pyrolizer, a gasifier, a calcination device, a transport reactor, a fixed bed-reactor, entrained flow reactor, a moving bed reactor, a fluid bed reactor, a bubbling bed reactor, a circulating bed reactor, an entrained bed reactor, a twin bed reactor, a rotary kiln reactor, a cyclonic reactor, a tank reactor, a tubular reactor, or other such devices.

The reactor 510 may also include one or more gas inputs 590 and one or more gas outputs 595. The gas inputs 590 may be configured to accept gases produced in other processes, such as in combustion processes, for introduction into the reactor 510. One or more gas inputs 590 may also be configured to introduce air or other oxygen-containing gas into the reactor 510. Oxygen may be introduced into the reactor 510 as air or a mixture of air and other gases flowing through one or more gas inputs 590. In other embodiments, one or more gas inputs 590 may be dedicated to the introduction of air separate from other gases being introduced into the reactor 510. Gases may exit the reactor 510 through one or more gas outputs 595 in the reactor 510.

The pollutant reaction process facility 500 according to particular embodiments of the invention may also include a thermal treatment material 520 and one or more thermal treatment material inputs 525 for introducing the thermal treatment material 520 into the reactor 510.

According to certain embodiments of the invention, thermal treatment material 520 may include oil shale. Oil shale used as a thermal treatment material 520 with various embodiments of the invention may include oil shale that has been pulverized or otherwise processed to produce oil shale particles suitable for thermal treatment within the reactor 510. For example, oil shale particles with sizes of about 2 μm or more may be fed to the reactor 510 as a thermal treatment material 520. The oil shale may also include oil shale particles which have been at least partially calcined, gasified, or combusted to release at least a portion of the kerogen contained in the oil shale prior to being introduced into the reactor 510.

According to other embodiments, thermal treatment material 520 may include a mixture of oil shale and coal. The presence of coal in the thermal treatment material 520 may provide a residual level of char within the reactor 510, which may improve the reduction of pollutants in the pollutant reaction process facility 500, and especially the reduction of NOₓ. According to still other embodiments of the invention, thermal treatment material 520 may include a mixture of oil shale with one or more additional thermally treatable materials, wherein the one or more additional thermally treatable materials are capable of being thermally treated within the reactor 510. The one or more additional thermally treatable materials may include, but are not limited to, coal, oil shale, fuels, biomass residuals, wood wastes, municipal solid wastes, and refuse derived fuels. As with the inclusion of coal, the additional thermally treatable materials may provide a residual level of char within the reactor 510. In addition, the inclusion of coal or additional thermally treatable materials with the thermal treatment material 520 may provide additional heat during thermal treatment or may enhance thermal treatment and pollutant reduction reactions occurring in the reactor 510.

The thermal treatment material 520 introduced into the reactor 510 may be thermally treated within one or more thermal treatment zones of the reactor 510 in the presence of gases introduced through the gas inputs 590. The thermal treatment of the oil shale-containing thermal treatment material 520 may produce shale sorbent particles. The thermal treatment of the oil shale-containing thermal treatment material 520 in the presence of gases introduced through the gas inputs 590 may reduce the amount of pollutants in the gases. The resulting off-gas from the pollutant reaction process facility 500 exits the one or more gas outputs 595 with fewer pollutants than the gases introduced through the gas inputs 590.

Waste materials 530 produced by the thermal treatment occurring in the reactor 510 may exit the reactor 510 and may be collected or transported elsewhere as desired. For example, the waste materials 530 may be utilized in another combustion process as a pollutant sorbent or as combustible material. In other embodiments, the waste materials 530 may be utilized as a material for construction materials such as in cement, road-bed materials, or other construction products.

The reduction of pollutants from gases introduced to the pollutant reaction process facility 500 according to embodiments of the invention results, at least in part, from the thermal treatment of oil shale in the reactor 510 in the presence of at least one pollutant-containing gas introduced through the one or more gas inputs 590.

The pollutant-containing gas introduced to the pollutant reaction process facility 500 may be produced from a pollution producing process, such as a pollution producing combustion process. For the sake of example only, the pollutant-containing gases may be produced from combustion gas, metallurgical offgas, cement kiln offgas, gasification or pyrolysis. The pollutant-containing gas may also be produced by a chemical process.

Oil shale has been used to decrease or eliminate one or more pollutants produced during the primary combustion of fuel in power plants, such as in power plants combusting coal, biomass, municipal solid waste, refuse derived fuel, or mixtures thereof. For example, U.S. patent application Ser. No. 11/004,698, the disclosure of which is incorporated herein by reference in its entirety, describes processes wherein oil shale may be added to a primary combustion process to reduce the amount of pollutants produced within the primary combustion chamber of a power plant combustion process. Oil shale introduced with the primary combustion materials may act as a sorbent to decrease the amount of pollutants released from the combustion chamber. In addition, the oil shale may produce a reductant capable of reducing pollutants formed in the combustion process to a more benign chemical species, decreasing the amount of pollutants formed in the combustion process.

According to various embodiments of the invention, oil shale is thermally treated downstream of a primary combustion process, or in an auxiliary combustion process, in the presence of pollutant-containing gases and particulates produced by one or more combustion processes to reduce the pollutants in those gases and particulates. Accordingly, pollutant-containing gases and particulates may be directed or fed to a pollutant reaction process facility 500 for thermally treating oil shale to reduce pollutants within the pollutant-containing gases.

The thermal treatment of oil shale in the presence of pollutant-containing gases or particulates may decrease or otherwise eliminate pollutants from the gases or particulates. For example, the thermal treatment of oil shale may decrease or eliminate pollutants such as nitrogen-containing pollutants, sulfur-containing pollutants, acid gases, and metals. Nitrogen-containing pollutants may include, for example, NO, NO₂, N₂O, N₂O₅, or mixtures thereof. Sulfur-containing pollutants may include, for example, SO₂, SO₃, H₂SO₄, H₂S, COS, CS₂, or mixtures thereof. In some instances, SO₂ may be a major sulfur-containing pollutant and SO₃ a minor sulfur-containing pollutant produced during combustion of primary fuels that contain sulfur. In other instances, H₂S may be a major sulfur-containing pollutant produced during gasification of sulfur-containing primary fuels. Acid gases may include, but are not limited to, halide-containing volatile gases, such as hydrochloric acid (HCl), chlorine (Cl₂), hydroiodic acid (HI), iodine (I₂), hydrofluoric acid (HF), fluorine (F), hydrobromic acid (HBr), bromine (Br), or mixtures thereof. Acid gases may also include phosphate-containing gases, such as phosphoric acid (H₃PO₄), phosphorus pentaoxide (P₂O₅), or mixtures thereof. Metal pollutants may include one or more elemental metals or one or more metal compounds including, but not limited to, elemental mercury (Hg°), mercuric chloride (HgCl₂), mercury adsorbed on particulate matter, lead (Pb) or compounds thereof, arsenic (As) or compounds thereof, chromium (Cr) or compounds thereof, or mixtures thereof.

Thermal treatment of oil shale in a thermal treatment material 520 produces shale sorbent particles that include shale minerals, such as oxides, carbonates, or silicates of calcium (Ca), magnesium (Mg), sodium (Na), potassium (K), iron (Fe), or zinc (Zn), and char particles or residual carbon. The thermal treatment of oil shale also produces kerogen, syngas, and other hydrocarbon gases. The products of the thermal treatment of oil shale are shown in Reaction 1:

oil shale shale minerals→char particles→kerogen→syngas→hydrocarbon gases (1).

The shale minerals and char particles in the shale sorbent particles are suitable for adsorbing and absorbing pollutants from gases or from particulates entrained in gases introduced to a reactor 510. The char particles may be present within the microstructure of the shale sorbent particles.

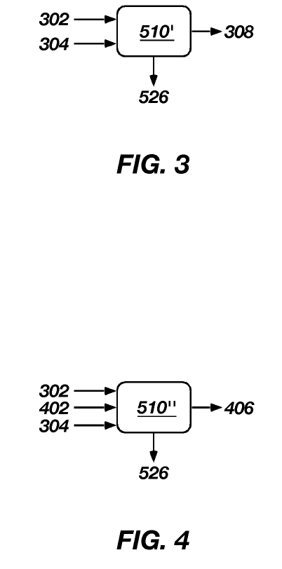

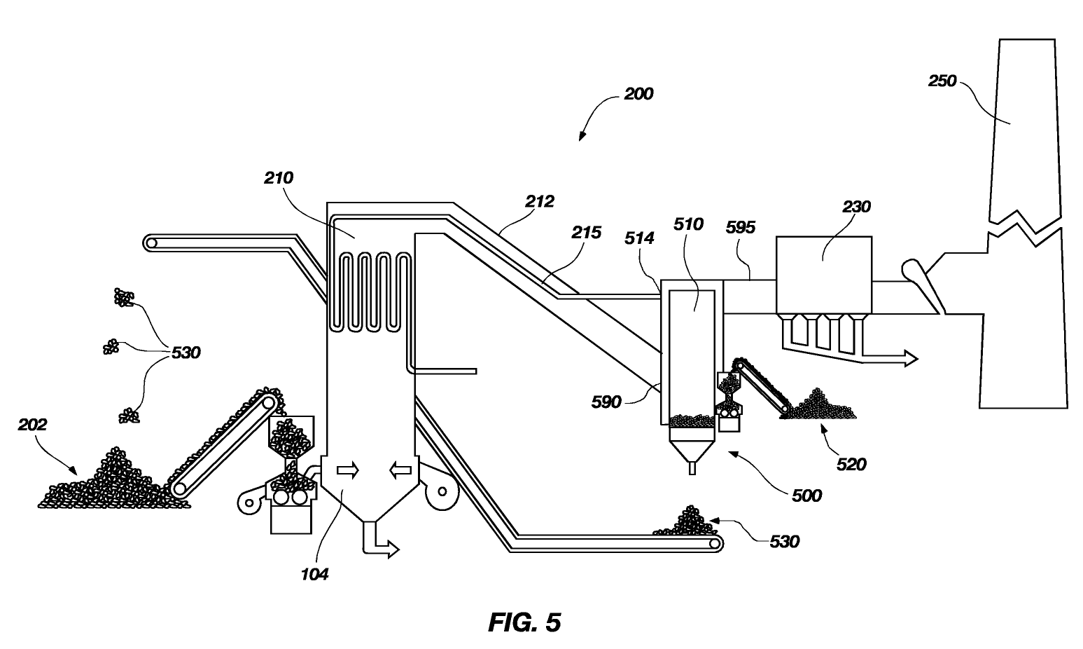

Shale sorbent particles 526 may be prepared under oxidizing, or combustion, conditions, as illustrated in FIG. 3. Oil shale 302 and an oxygen-containing gas 304, such as oxygen or air, may be introduced into a combustion chamber 510′ and combusted under oxidizing conditions to produce the shale sorbent particles 526 and at least one combustion gas 308. The shale sorbent particles 526 may, alternatively, be prepared under reducing, or gasification, conditions, as illustrated in FIG. 4. The oil shale 302, the oxygen-containing gas 304, and steam 402 may be introduced into a gasifier 510″ and gasified under reducing conditions to produce the shale sorbent particles 526 and syngas 406. Depending on the configuration and operating conditions of the gasifier 510″, the shale sorbent particles 526 may include a higher carbon content than those produced under oxidizing conditions. The shale sorbent particles 526 may be produced in the reactor 510 at an onsite location and utilized in the combustion process facility 200 (see FIG. 5). However, the shale sorbent particles 526 may also be produced at an onsite location separate from the combustion process facility 200 and subsequently utilized in the combustion process facility 200. Alternatively, the shale sorbent particles 526 may be produced at an offsite location and transported to a location of the combustion process facility 200. In addition to oil shale 302, other thermally treatable materials may be used, as previously described.

The shale sorbent particles 526 produced by the thermal treatment of oil shale result, in part, from the devolatilization of kerogen from the oil shale within the reactor 510. The pyrolization of oil shale releases kerogen which may depolymerize and devolatilize, resulting in the calcination of the shale minerals. The extent of depolymerization, devolatilization, pyrolysis, and char formation of the oil shale may vary depending on particle heat-up rates, particle temperature, surrounding gas temperatures, and the amount of time that the oil shale is thermally treated within the reactor 510. For example, temperatures of greater than or equal to about 200° C. may be sufficient to pyrolize oil shale in some embodiments, releasing kerogen from the oil shale. The shale sorbent particles 526 produced by the pyrolization of the oil shale may have an increased adsorption or absorption capability relative to that of the oil shale and may be used to adsorb or absorb mercury and other pollutants. The shale sorbent particles 526 may provide additional available surface area and porosity, allowing pollutants to readily diffuse into the shale sorbent particles 526 and react with or be adsorbed by the shale minerals contained within the shale sorbent particles 526. The additional porosity of the shale sorbent particles 526 may be due to the presence of void areas and fracturing caused by gasification and calcination reactions.

Carbonate or oxide compounds in the shale sorbent particles 526 produced by the thermal treatment of the oil shale in the reactor 510 may be used to remove sulfur-containing pollutants, such as H₂SO₄, SO₃, SO₂, H₂S, COS, CS₂, or mixtures thereof, from gases and particulates fed to the reactor 510. The reaction of the sulfur-containing pollutants with the shale sorbent particles 526 may produce stable sulfates. Sulfur-containing pollutants may be reacted with the shale sorbent particles 526 according to the chemistries shown in Reactions 2-10:

Mₓ−(CO₃)_{y}+heat→Mₓ−O_{y}+yCO₂ (2),

CaCO₃+SO₂+1/2O₂→CaSO₄+CO₂ (3),

CaCO₃+SO₃→CaSO₄+CO₂ (4),

CaCO₃+H₂SO₄→CaSO₄+CO₂+H₂O (5),

CaCO₃+H₂S→CaS+H₂O+CO₂ (6),

CaO+SO₂+1/2O₂→CaSO₄ (7),

CaO+SO₃→CaSO₄ (8),

CaO+H₂SO₄→CaSO₄+H₂O (9),

CaO+H₂S→CaS+H₂O (10),

where M is a metal, such as Ca, Mg, Na, K, Fe, or Zn, and where x and y vary depending on the metal carbonates present in the oil shale. For instance, x may be 1 or 2 and y may be 1, 2, or 3. While the reactions shown above are between SO₂, SO₃, H₂SO₄, or H₂S and calcium carbonate or calcium oxide, similar reactions may occur between SO₂, SO₃, H₂SO₄ or H₂S and carbonates or oxides of Mg, Na, K, Fe, or Zn.

When COS, CS₂, or a combination of COS and CS₂ are introduced with gases or particulates fed to the reactor 510, COS and CS₂ may be shifted to H₂S using a shift reaction according to the Reactions 11 and 12:

COS+H₂O→H₂S+CO₂ (11),

CS₂+2H₂O→2H₂S+CO₂ (12).

The shift reactions illustrated by Reactions 11 and 12 may be promoted by Ca, Mg, Na, K, Cu, Fe, Al, and other elements or mineral compounds contained in the oil shale or the shale sorbent particles 526 in the reactor 510. The H₂S formed by the conversion of COS or CS₂ to H₂S may be further converted according to Reactions 6 and 10.

Carbonate or oxide compounds in the shale sorbent particles 526 may also be used to remove hydrochloric acid (HCl) and chlorine (Cl₂) according to the example chemistries shown in Reactions 13 and 14:

CaO+2HCl→CaCl₂+H₂O (13),

CaO+Cl₂→CaCl₂+1/2O₂ (14).

While Reactions 13 and 14 illustrate reactions between calcium oxide and chlorine-containing compounds, similar reactions may occur between HCl or Cl₂ and oxides or carbonates of Mg, Na, K, Fe, or Zn. Similar reactions may also occur with fluorine, fluorine-containing compounds, iodine, iodine-containing compounds, bromine, bromine-containing compounds, phosphate, and phosphate-containing compounds. The adsorption or absorption of such compounds by the shale sorbent particles 526 within a reactor 510 may occur at an operating temperature sufficient to achieve favorable reaction of the fluorine, fluorine-containing compounds, iodine, iodine-containing compounds, bromine, bromine-containing compounds, phosphate, and phosphorus-containing compounds with the alkali compounds, alkaline-earth compounds, or other metal oxides present in the oil shale and shale sorbent particles 526 to produce halogen or phosphorus compounds. However, the temperature may be less than the dissociation temperatures of the compounds. For example, for the reaction of HCl with shale sorbent particles 526, the temperature of the reaction in the reactor 510 may be maintained from about 450° C. to about 1150° C.

In some embodiments of the invention, the release of kerogen from oil shale thermally treated in a reactor 510 may also provide a reductant that reduces nitrogen-containing pollutants in gases and particulates introduced to the reactor 510 through the gas inputs 590. As shown in Reaction 15, the kerogen may be exposed to additional heat resulting in the cracking or scission of the kerogen, forming light and heavy hydrocarbons:

kerogen+heat+radicals→heavy and light hydrocarbons (CₓH_{y})+CO+H₂+CO₂ (15),

where x and y depend on the carbon and hydrogen ratio in the kerogen and temporal conditions. For instance, x may range from about 1 to about 7 for a light hydrocarbon, from about 8 to about 13 for an intermediate hydrocarbon, or from about 14 to about 42 for heavy hydrocarbons. In most instances, y may range from about 1 to about 90 and is typically equal to about two times x for a given hydrocarbon. A temperature of greater than or equal to about 350° C. may be used to crack and scission the polymeric kerogen. The heavy and light hydrocarbons formed in the reactor 510 may be used to reduce the nitrogen-containing pollutants to molecular nitrogen (N₂), carbon dioxide (CO₂), and water (H₂O) according to the chemistries shown in Reactions 3 and 4:

CₓH_{y}+(2x+y/2)NO→(x+y/4)N₂+xCO₂+y/2H₂O (16),

CₓH_{y}+(x+y/4)NO₂→(x/2+y/8)N₂+xCO₂+y/2H₂O (17),

where x is about 1 or 2 and y is about 1, 2, 3, or 4. Such reactions may occur at temperatures of about 400° C. or greater. Generally, Reactions 16 and 17 show the reduction of oxidized compounds of nitrogen to a reduced nitrogen compound, such as N₂. Char particles in the shale sorbent particles 526 may also reduce nitrogen-containing pollutants to N₂, CO₂, and H₂O by heterogeneous reactions according to, or similar to, the chemistries shown in Reactions 18 and 19:

Char+(2+x)NO→1/2(2+x)N₂+yCO₂+zH₂O (18),

Char+(2+x)NO₂→1/2(2+x)N₂+yCO₂+zH₂O (19),

where x, y, and z are dependent on the carbon to hydrogen ratio in the char.

The release of kerogen from the oil shale in the thermal treatment material 520 in the presence of gases introduced through gas input 590 may react with nitrogen-containing pollutants in the gases, reducing the overall nitrogen pollution in the gases within the reactor 510.

In those embodiments where the thermal treatment material 520 includes coal or another thermally treatable material which produces char upon thermal treatment, the produced char may facilitate the reduction of nitrogen-containing pollutants introduced to the pollutant reaction process 500. Char produced by the thermal treatment of coal or other thermally treatable material in the pollutant reaction process 500 may convert NOₓ pollutants according to Reactions 18 and 19.

The thermal treatment of oil shale in a pollutant reaction process as conducted in a facility 500 may be used to remove a single pollutant or multiple pollutants from gases, particulates, or combinations of gases and particulates introduced into a reactor 510. According to some embodiments of the invention, the thermal treatment of oil shale in the reactor 510 may remove nitrogen-containing pollutants, H₂SO₄, SO₃, H₂S, COS, CS₂, SO₃, elemental mercury, and mercuric chloride from any gases or particulates introduced to the reactor 510 through the gas inputs 590.

Therefore, according to particular embodiments of the invention, pollutants may be removed from gases and particulate matter by exposing the pollution containing gases and particulates to thermally treated oil shale or oil shale undergoing thermal treatment in the pollutant reaction process of a facility 500.

According to particular embodiments of the invention, one or more reactors 510 may be incorporated into a combustion or other production process to reduce pollutants formed in the process of a combustion or other energy production facility 100. For example, a reactor 510 may be incorporated into a combustion or other production process facility to reduce pollutants from gases, particulates, or mixtures thereof produced in the combustion or other production process, as illustrated by combustion process facility 200 in FIG. 5. The pollutant-containing gases introduced to the pollutant reaction process facility 500 may be produced by combustion process facility 200 and may include pollutants in a combustion gas, metallurgical offgas, cement kiln offgas, gasification or pyrolysis.

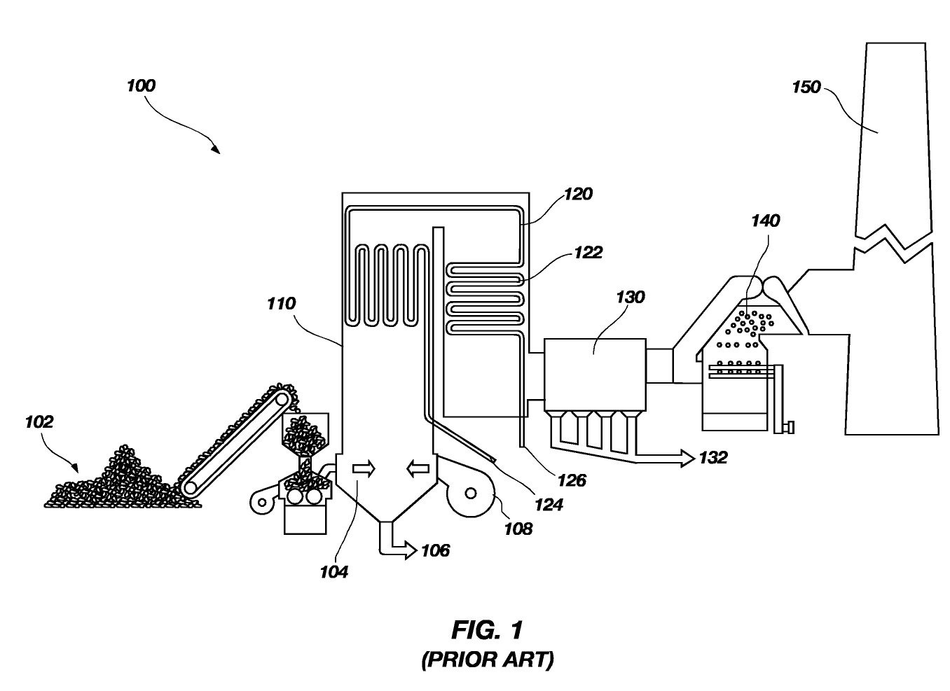

In particular embodiments of the invention, a pollutant reaction process apparatus such as facility 500 may be designed or retrofit to an existing facility for combustion or other production process to assist with the reduction of pollutants produced by the combustion or other production process. For example, in an existing combustion or other energy production process facility, such as that illustrated in FIG. 1, a pollutant reaction process facility 500, including a reactor 510, may be incorporated with the combustion or production process facility 100, resulting in a combustion process facility 200 as illustrated in FIG. 5. The retrofit of the combustion or other production process equipment may allow the primary combustor to be operated with greater flexibility with less worry about the production of pollutants. For example, the combustion process facility 200 may be operated to maximize burnout or heat transfer within the primary combustion process without regard to the formation of pollutants, such as hydrocarbon emissions, particulate emissions, NOₓ emissions, or flyash releases. Such operation is possible because the pollutants produced in the combustion process facility 200 may be reduced or eliminated when the gases from the combustion process facility 200 are fed to the reactor 510 of the pollutant reaction process facility 500. Thus, hydrocarbons, NOₓ pollutants, SOₓ pollutants, and unwanted metal pollutants may be simultaneously reduced or eliminated from the produced gases and particulates by the pollutant reaction process facility 500.

The process facility 200 illustrated in FIG. 5 may include conventional combustion process equipment, such as a boiler 210, a baghouse/precipitator 230, and a stack 250. The boiler 210 may include any type of boiler or thermal combustion process capable of producing heat. The combustible material 202 fed to the boiler 210 may include materials including, but not limited to, fuels, coal, and waste materials, which produce heat when combusted within the boiler 210. Gases formed by the combustion of the combustible material 202 may exit the boiler 210 as outlet gas 212. The outlet gases 212 may include off-gases from the combustion process 200 and may also include entrained particulate matter. According to certain embodiments of the invention, the outlet gases 212, and any particulate matter entrained therein, may be fed to one or more gas inputs 590 of the pollutant reaction process facility 500, such as to reactor 510 configured to remove pollutants from the outlet gases 212. In other particular embodiments of the invention, the outlet gases 212 and any entrained particulates may be routed to another process, such as a further combustion process or treatment process, prior to being fed to one or more of the gas inputs 590 of a reactor 510 incorporated with the process 200.

Outlet gases 212 fed to the reactor 510 are exposed to the thermal treatment processes occurring within the reactor 510. Exposure of the outlet gases 212 to the thermal treatment of the thermal treatment material 520 may reduce or eliminate pollutants contained in the outlet gases 212 according to various embodiments of the invention. For example, the thermal treatment of oil shale-containing thermal treatment material 520 in the reactor 510 may produce kerogen and shale sorbent particles 526. The kerogen may act as a reductant, reducing nitrogen-containing pollutants in the outlet gases 212 and entrained particulates or otherwise removing or converting other pollutants to non-polluting substances. The shale sorbent particles 526 formed in the reactor 510 may absorb, adsorb, capture, or otherwise trap or convert the pollutants, such as nitrogen-containing pollutants, sulfur-containing pollutants, acid gases, metals, and mixtures thereof, introduced with the outlet gases 212 and entrained particulates. Accordingly, pollutants introduced to the reactor 510 with the outlet gases 212 and any entrained particulates may be removed or reduced from the outlet gases 212 and the entrained particulates.

For instance, outlet gases 212 fed to a reactor 510 according to embodiments of the invention may be exposed to the shale sorbent particles 526 in the reactor 510 and the shale sorbent particles 526 may adsorb, absorb, or otherwise capture pollutants in the outlet gases 212 according to Reactions 2-14, 18, and 19. The exposure of the outlet gases 212 to the kerogen released from the thermal treatment of the oil shale may reduce pollutants in the outlet gases 212 according to Reactions 15-17. Other nitrogen-containing pollutants may also be reduced from the outlet gases 212 according to Reactions 18 and 19.

In some embodiments of the invention, the placement of the pollutant reaction process facility 500 within the combustion process facility 200 or the location at which the pollutant-containing gases and particulates are directed from the combustion process facility 200 to the pollutant reaction process facility 500 may also facilitate the filtration of particulates and fly ash from the combustion process of facility 200. The pollutant reaction process facility 500 may eliminate or filter particulates and fly ash from the gases produced in the combustion process facility 200 which are fed to the pollutant reaction process facility 500 with outlet gases 212. Capture of particulates and fly ash in the shale sorbent particles 526 and other char particulates within the pollutant reaction process of facility 500 may reduce the amount of particulates and fly ash to be removed by any downstream filtration devices in the combustion process facility 200.

According to some embodiments of the invention, a reactor 510 utilized with the pollutant reaction process facility 500 may be installed with any of a water-membrane wall, a gas-steam superheater, or other heat exchanger to recover the heat generated by the thermal treatment process occurring within the reactor 510. Steam produced by the reactor 510 may be used as a source of heat elsewhere in the pollutant reaction process of facility 500 or in the combustion process of facility 200. For example, as illustrated in FIG. 5, steam or heated water produced within the reactor 510 may be fed to the boiler 210 through pipes 215.

According to still other embodiments of the invention, at least a portion of the char or waste materials 530 produced by the thermal treatment of thermal treatment material 520 in one or more reactors 510 in the pollution reduction process facility 500 may be recycled and included with the combustible material 202 fed to the boiler 210 or other thermal combustion process. The waste materials 530 may be used as an additional combustion material or as a pollutant reactant material. Thermally treated oil shale and shale sorbent particles that have not been completely thermally treated may be mixed with a combustion material for a combustion process to provide additional enthalpy value to the combustion process. For example, as illustrated in FIG. 5, char or waste materials 530 produced in the reactor 510 may be collected and mixed with combustible material 202 fed to the boiler 210. The char or waste materials 530 may be collected using various processes including, but not limited to, collection and transportation by a conveyor belt or other delivery system, collection and storage in a holding position before being mixed with the combustible material 202, or by other conventional processes configured to deliver and mix a first material with a second material.

The inclusion of char or waste materials 530 with the combustion material 202 in the combustion process of facility 200 may further help to reduce pollutants formed during the combustion of the combustion material 202. The presence of the shale sorbent particles 526 in the char or waste materials 530 added to the combustion material 202 may absorb, adsorb, or otherwise trap or convert pollutants formed by the combustion of the combustible material 202 in the boiler 210. If the char or waste material 530 includes shale sorbent particles 526 or oil shale containing residual kerogen, the kerogen may also be released during combustion in the boiler 210 with the combustion material 202. The release of additional kerogen in the boiler 210 may also help to reduce or eliminate certain pollutants formed in the boiler 210.

The use of the char or waste material 530 with the combustible material 202 may also help to facilitate the combustion of the combustible material 202. Char or waste material 530 from the reactor 510 may provide an additional source of enthalpy (i.e., heating value) to a combustion process occurring in a boiler 210 or other thermal combustion process. Char or waste material 530 that was not fully thermally treated or combusted within the reactor 510 may be further combusted within the boiler 210 or other combustion process, producing additional char particles and heavy or light hydrocarbons. For example, the combustion of char and heavy and light hydrocarbons in the char or waste material 530 may occur according to Reactions 20-27, which may provide additional energy in the form of heat to the combustion occurring in the boiler 210 or other combustion process.

CₓH_{y}+(x+y/4)O₂→xCO₂+y/2H₂O (20),

CO+1/2O₂→CO₂ (21),

CₓH_{y}+x/2O₂→xCO+y/2H₂ (22),

CₓH_{y}+xH₂O→xCO+(x+y/2)H₂ (23),

Char carbon+O₂→CO₂ (24),

Char carbon+1/2O₂→CO (25),

Char carbon+CO₂→2CO (26),

Char carbon+H₂O→CO+H₂ (27).

Reactions 20-22 may occur at a temperature greater than or equal to approximately 200° C. and Reactions 21-27 may occur at a temperature greater than or equal to approximately 400° C. While not all of Reactions 20-27 are exothermic, the reactions either produce heat or produce reactive gases that may be used to produce heat.

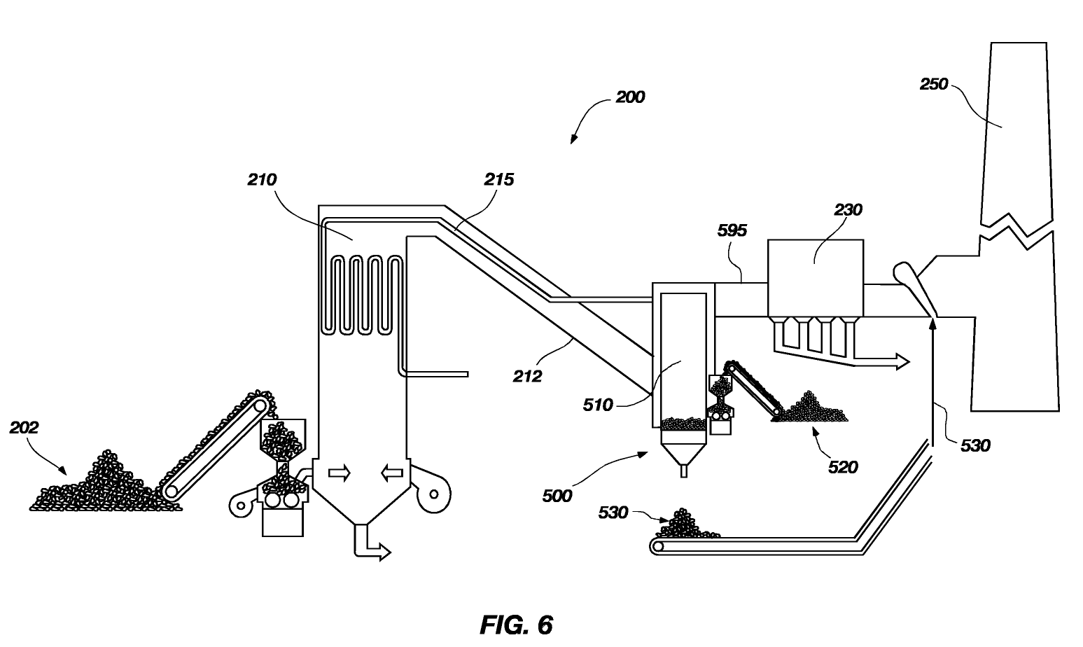

According to other embodiments of the invention, at least a portion of the char or waste materials 530 produced by one or more reactors 510 in the pollution reaction process 500 may be used as a sorbent in the combustion process of facility 200 to absorb, adsorb, or otherwise capture pollutants in other parts of the combustion process of facility 200. For example, as illustrated in FIG. 6, the char or waste materials 530 produced by the reactor 510 may be directed to the output of a baghouse/precipitator 230 or to the input of a stack 250 to absorb, adsorb, or otherwise trap or capture mercury-containing pollutants from gases or gases with entrained particulates entering the baghouse/precipitator 230 or stack 250 in the combustion process 200. Although FIG. 6 illustrates transport of the char or waste products 530 from the reactor 510 to the stack 250, at least a portion of the char or waste material 530 may transported to the stack 250 rather than all of the char or waste material 530.

Char or waste materials 530, such as shale sorbent particles 526, may act as a metal pollutant sorbent, such as a mercury pollutant sorbent. Shale minerals and char particles in the shale sorbent particles 526 may have an affinity for physical bonding with mercury or mercury-containing compounds, resulting in the absorption of mercury. Therefore, the shale minerals or char particles produced by the pyrolysis of the oil shale (Reaction 1) in the reactor 510 may adsorb or absorb mercury or mercuric chloride according to the chemistries shown in Reactions 28-31:

char particles+Hg°→char particles-Hg° (28),

char particles+HgCl₂→char particles-HgCl₂ (29),

shale minerals+Hg°→M—Hg° (30),

shale minerals+HgCl₂→M—HgCl₂ (31),

where M is a metal or metal compound present in the char or waste material 530 that has affinity for mercury or mercuric chloride. M may include, but is not limited to, any one of Fe, Zn, lead (Pb), silver (Ag), aluminum (Al), cadmium (Cd), chromium (Cr), nickel (Ni), titanium (Ti), selenium (Se), or arsenic (As). When the char or waste materials 530 come into contact with these pollutants for a sufficient residence time, the shale sorbent particles 526 may capture the elemental mercury or mercuric chloride. The adsorption or absorption of the elemental mercury or mercuric chloride by the shale minerals or char particles may also depend on a temperature at which the shale minerals or char particles contact the elemental mercury or mercuric chloride. The temperature of the char or waste materials 530 may be maintained so that they are reintroduced into the combustion process of facility 200 to adsorb or absorb the pollutants at a temperature favorable for chemical or physical adsorption, such as at a temperature of less than or equal to approximately 200° C.

The char or waste materials 530 may also be used to remove other volatile and semi-volatile metals produced in the combustion process of facility 200. For example, char or waste materials 530 may be introduced into various portions of the process to remove pollutants such as lead, arsenic, beryllium, and other metals from various product and production streams of the combustion process of facility 200.

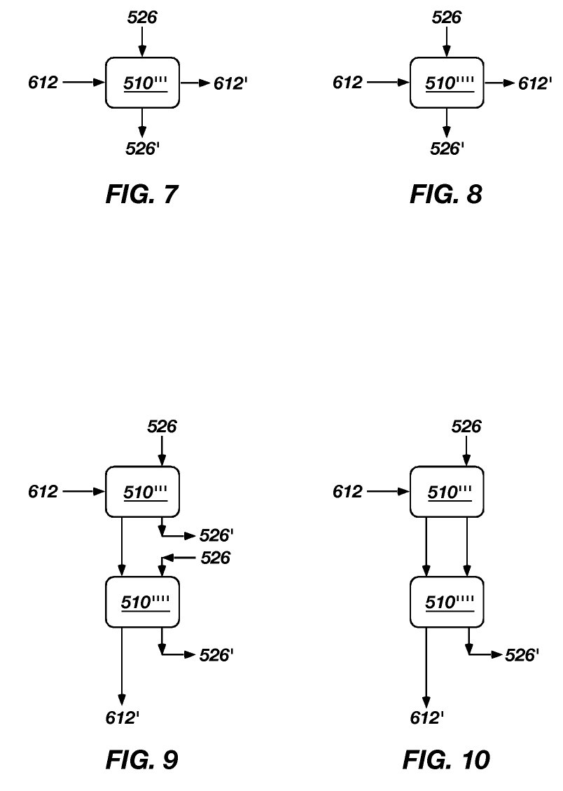

The ability of the shale sorbent particles 526 to remove at least one pollutant may depend on the particular pollutant to be removed and a temperature at which the pollutant(s) and the shale sorbent particles 526 come into contact. Sulfur-containing pollutants may react with, and be removed by, the shale sorbent particles 526 at a temperature of from about 800° C. to about 1000° C. Halogen-containing pollutants, such as chlorine-containing pollutants, may react with, and be removed by, the shale sorbent particles 526 at a lower temperature, such as at a temperature between about 450° C. and about 1150° C. Mercury-containing pollutants may react with, and be removed by, the shale sorbent particles 526 at a lower temperature, such as at a temperature less than or equal to about 200° C. for capture by iron, at a temperature equal to about 600° C. for capture by sulfur, or at another temperature for capture by forming other amalgams. Therefore, depending on the pollutants present in the pollutant-containing gas and the pollutants targeted for removal, a high temperature reactor, a low temperature reactor, or combinations thereof may be used to remove specific pollutants produced by the combustion process of facility 200. For the sake of example only, as illustrated in FIG. 7, if a pollutant-containing gas 612 includes at least one of sulfur-containing pollutants and halogen-containing pollutants, the pollutant-containing gas 612 may be introduced to a high temperature reactor 510′″ maintained at a temperature between about 800° C. and about 1000° C. or between about 450° C. and about 1150° C. The pollutant-containing gas 612 may be flowed over, or otherwise contacted with, the shale sorbent particles 526, removing at least one of the sulfur-containing pollutants and the halogen-containing pollutants and producing a substantially pollutant free gas 612′. For the sake of example only, as illustrated in FIG. 8, if mercury-containing pollutants are to be removed from the pollutant-containing gas 612, the pollutant-containing gas 612 may be introduced to a low temperature reactor 510″″ maintained at a temperature of less than or equal to about 200° C. The pollutant-containing gas 612 may be flowed over, or otherwise contacted with, the shale sorbent particles 526 to produce the substantially pollutant free gas 612′. Spent shale sorbent particles 526′, which are loaded or contaminated with the pollutants, may be removed from the high temperature reactor 510′″ or from the low temperature reactor 510″″. The spent shale sorbent particles 526′ may be disposed of or used in a secondary process.

If the pollutant-containing gas 612 includes multiple types of pollutants, such as sulfur-, mercury-, and chlorine-containing pollutants, multiple reactors maintained at different temperatures may be used to remove the pollutants. For the sake of example only, as shown in FIGS. 9 and 10, the pollutant-containing gas 612 may be introduced to the high temperature reactor 510′″ containing the shale sorbent particles 526 to remove the sulfur-containing pollutants and the chlorine-containing pollutants, and to a low temperature reactor 510″″ containing the shale sorbent particles 526 to remove the mercury-containing pollutants. While FIGS. 9 and 10 illustrate the pollutant-containing gas 612 entering the high temperature reactor 510′″ first, the pollutant-containing gas 612 may be flowed through the low temperature reactor 510″″ first. The pollutant-containing gas 612 may be flowed over, or otherwise contacted with, the shale sorbent particles 526 in the high and low temperature reactors 510′″, 510″″ to remove the sulfur-, mercury-, and chlorine-containing pollutants, producing the substantially pollutant free gas 612′.

If multiple reactors 510 are used, the high and low temperature reactors 510′″, 510″″ may be configured for parallel flow (FIG. 9) or sequential flow (FIG. 10) of the shale sorbent particles 526. As shown in FIG. 9, spent shale sorbent particles 526′ may be removed from the high temperature reactor 510′″ after flowing the pollutant-containing gas 612 through the high temperature reactor 510′″. Additional shale sorbent particles 526 may be introduced into the low temperature reactor 510″″ before flowing the pollutant-containing gas 612 through the low temperature reactor 510″″. In contrast, as shown in FIG. 10, the shale sorbent particles 526 may be transferred from the high temperature reactor 510′″ to the low temperature reactor 510″″. The parallel flow of the shale sorbent particles 526 may be beneficial in situations where the spent shale sorbent particles 526′ are used in a secondary process. For the sake of example only, if the shale sorbent particles 526 are used to remove sulfur-containing pollutants, the spent shale sorbent particles 526′ may be removed and used in used in a cement kiln, such as in a cement klinker. Alternatively, the spent shale sorbent particles 526′ may be used as a material for construction materials such as in cement, road-bed materials, or other construction products

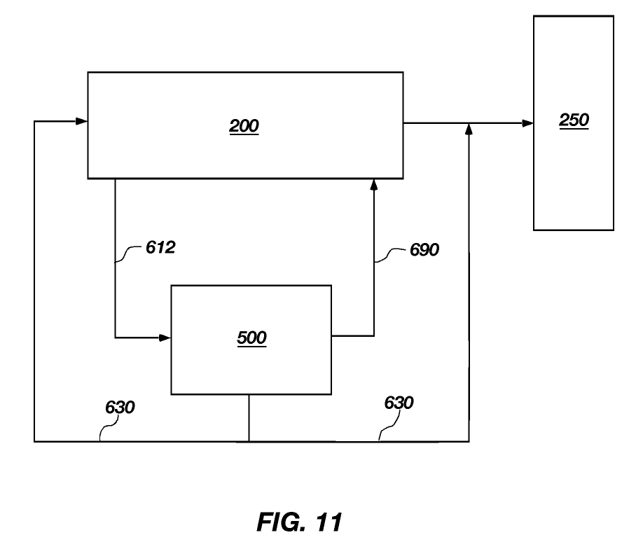

According to other various embodiments of the invention, the combustion process of facility 200 may include any pollution producing combustion process and the pollutant reaction process of facility 500 may include any thermal treatment process capable of thermally treating oil shale to release kerogen from the oil shale or to produce shale sorbent particles 526. As illustrated in FIG. 11, the pollutant-containing gas 612 from the combustion process 200 may be fed to a pollutant reaction process of a facility 500. Pollutants in the pollutant-containing gas 612, and in any particulates entrained in the pollutant-containing gas 612, may be at least partially removed during the pollutant reaction process of facility 500. Off-gases 690 from the pollutant reaction process of facility 500 may be fed back to the combustion process of facility 200 or fed to an additional pollution reduction apparatus (not shown), such as stack 250, while the substantially pollutant free gas 612′ (not shown) may be released to the environment or utilized in a secondary process. Waste materials 630 from the pollutant reaction process of facility 500, such as char, spent shale sorbent particles 526′, and uncombusted oil shale, may be fed to the combustion process of facility 200 to be included with combustible material 202 (not shown). Waste materials 630 may also be fed to other portions of the combustion process of facility 200 to absorb, adsorb, or otherwise capture pollutants in the combustion process of facility 200. For example, the waste materials 630 may be fed to the stack 250 to assist in cleaning pollutants from gases and particulates fed to the stack 250. The waste materials 630 may also be stored or otherwise disposed. The spent shale sorbent particles 526′ may be removed from the pollutant reaction process 500 and disposed of or used in a secondary process including, but not limited to, a construction material, such as in cement, road-bed materials, or other construction products.

While particular embodiments of the invention have been described and illustrated with respect to the reduction of pollutants from power-plant off-gasses, and particularly coal-fired power plants, the particular pollution reduction processes, methods, and apparatuses of embodiments of the invention may be used with other processes, such as mining and mineral processes and industrial processes, to help reduce pollutant emissions from such processes. For example, combustion processes of a facility 200 that may be incorporated with one or more pollutant reaction processes of a facility 500 of the invention may include a pulverized coal boiler, a cement production process, a cement kiln, a synfuel or syngas production process, a metallurgy pyrolysis process, a pulverized coal combustor, a smelter, a furnace, a boiler, a retort, a pyrolizer, a gasifier, a calcination device, an ore refining process, a metal refining process, a fluidized-bed combustor or gasifier, a circulating-bed combustor or gasifier, a staged reactor combustor or gasifier, an entrained-flow combustor or gasifier, an off-gas duct, and an off-gas clean-up transport reactor.

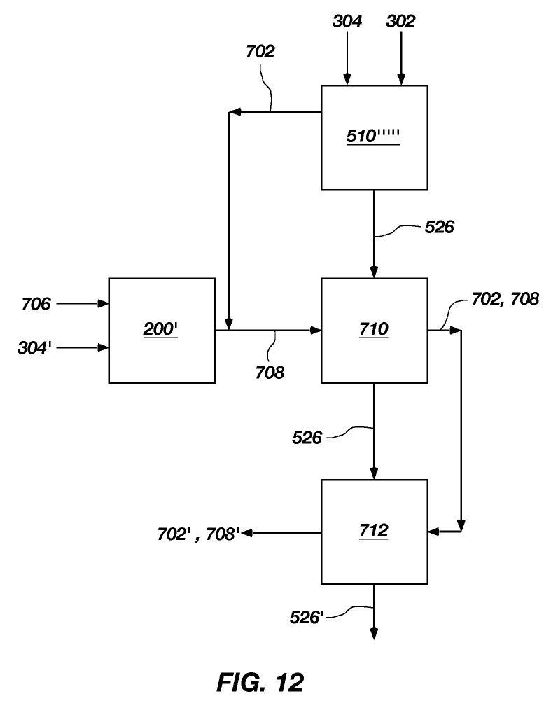

In another embodiment, at least one pollutant is removed from syngas produced by at least one gasification process. As a result of the gasification, the syngas may have an elevated temperature. The shale sorbent particles 526 may be used to remove the pollutants without first cooling the syngas. An oil shale gasification process may be used in conjunction with a fuel gasification process to remove the pollutants produced by the fuel and oil shale gasification processes. As illustrated in FIG. 12, an oxygen-containing gas 304, such as oxygen or air, and oil shale 302 may be introduced into a first gasifier 510′″″ configured to conduct the oil shale gasification process. The oil shale 302 may be gasified, producing a first gas 702, kerogen, and the shale sorbent particles 526. The first gas 702 may include syngas and other hydrocarbon gases. The first gasifier 510′″″ may utilize oxygen obtained from a second gasifier 200′ or waste heat and steam obtained from the second gasifier 200′ to produce the heat to release and gasify the kerogen in the oil shale 302. The shale sorbent particles 526 may be maintained at an elevated temperature until used to remove the pollutants from the syngas. The elevated temperature may be a temperature between about 500° C. and 1000° C. The first gas 702 may also be maintained at the elevated temperature.

An oxygen-containing gas 304′, such as oxygen or air, and a fuel 706 may be introduced to the second gasifier 200′, which is configured to conduct the fuel gasification process. The fuel 706 may be a feedstock of coal, biomass, solid waste or refuse derived fuel, or other bulk fuel capable of being gasified. The fuel 706 may be gasified in the second gasifier 200′, producing syngas 708 having at least one pollutant. The syngas 708 may also be maintained at the elevated temperature. The first gas 702, maintained at the elevated temperature, may exit the first gasifier 510′″″ and be combined with the syngas 708, also maintained at the elevated temperature. The kerogen and shale sorbent particles 526 may be transported from the first gasifier 510′″″ to a first sorbent reactor 710 and maintained at the elevated temperature. The first gas 702 and the syngas 708 may be flowed into the first sorbent reactor 710 and over the kerogen and shale sorbent particles 526. The kerogen and shale sorbent particles 526 may be contacted with the first gas 702 and the syngas 708 at a temperature between about 500° C. and 1000° C. At a temperature within this range, sulfur-containing pollutants in the first gas 702 and the syngas 708 may react with the shale minerals in the shale sorbent particles 526 to form immobile sulfate compounds. As such, the sulfur-containing pollutants may be removed from the first gas 702 and the syngas 708. Halogen-containing pollutants, such as chlorine-containing pollutants, may also react at a temperature within this range to produce calcium chloride. As such, the halogen-containing pollutants may also be removed from the first gas 702 and the syngas 708. Since the reaction of the shale minerals in the shale sorbent particles 526 with the sulfur-containing pollutants and the halogen-containing pollutants occurs at relatively high temperatures, the shale sorbent particles 526 may be maintained at the elevated temperature, enabling these pollutants to be removed without cooling and reheating the first gas 702 and syngas 708.

The first gas 702 and the syngas 708 may be flowed into a second sorbent reactor 712 having kerogen and shale sorbent particles 526 that have been cooled to a temperature of less than or equal to about 200° C. At this temperature, mercury-containing pollutants may be removed from the first gas 702 and the syngas 708. The mercury-containing pollutants may be reacted with or adsorbed by the shale minerals or char particles in the shale sorbent particles 526, removing elemental mercury or mercuric chloride.

By removing the sulfur-containing pollutants, the halogen-containing pollutants, and the mercury-containing pollutants, a substantially pollutant free syngas 702′, 708′ may be produced. The spent shale sorbent particles 526′ may be removed from the first and second sorbent reactors 710, 712 and disposed of or used in a secondary process. By flowing the first gas 702 and the syngas 708 through the kerogen and shale sorbent particles 526, the pollutants may be substantially removed. In addition, the efficiency of the fuel gasification process may be improved by eliminating cooling and reheating of the syngas before removing the pollutants. Furthermore, since a pair of reactors may be used to remove the pollutants, the complexity of the fuel gasification process may be reduced.

Having thus described certain currently preferred embodiments of the present invention, it is understood that the invention defined by the appended claims is not to be limited by particular details set forth in the above description, as many apparent variations thereof are contemplated without departing from the spirit or scope thereof as hereinafter claimed.

What is claimed is:

1. A method of removing at least one pollutant from a pollutant-containing gas, comprising:
thermally treating oil shale in the presence of a pollutant-containing gas.

2. The method of claim 1, wherein thermally treating oil shale in the presence of a pollutant-containing gas comprises thermally treating the oil shale in the presence of the pollutant-containing gas comprising at least one pollutant selected from the group consisting of a nitrogen-containing pollutant, a sulfur-containing pollutant, a halide-containing volatile gas, a phosphate-containing gas, and a metal pollutant.

3. The method of claim 1, wherein thermally treating oil shale in the presence of a pollutant-containing gas comprises thermally treating the oil shale in the presence of the pollutant-containing gas comprising at least one pollutant selected from the group consisting of NO, NO₂, N₂O, N₂O₅, SO₂, SO₃, H₂SO₄, H₂S, COS, CS₂, HCl, Cl₂, HI, I₂, HF, F, HBr, Br, H₃PO₄, P₂O₅, Hg°, HgCl₂, Pb, As, and Cr.

4. The method of claim 1, wherein thermally treating oil shale in the presence of a pollutant-containing gas comprises thermally treating oil shale in the presence of a pollutant-containing gas comprising at least one of at least one gas and particles entrained in the pollutant-containing gas.

5. The method of claim 1, wherein thermally treating oil shale in the presence of a pollutant-containing gas comprises thermally treating the oil shale in the presence of the pollutant-containing gas produced by a combustion process.

6. The method of claim 1, wherein thermally treating oil shale in the presence of a pollutant-containing gas comprises combusting, gasifying, retorting, pyrolyzing, or heating the oil shale in the presence of the pollutant-containing gas.

7. The method of claim 1, wherein thermally treating oil shale in the presence of a pollutant-containing gas comprises producing at least one of kerogen, decomposed kerogen, depolymerized kerogen, and shale sorbent particles from the oil shale.

8. The method of claim 7, further comprising reacting at least a portion of the kerogen with at least a portion of the pollutant-containing gas.

9. The method of claim 7, further comprising reacting at least a portion of the shale sorbent particles with at least a portion of the pollutant-containing gas.

10. The method of claim 1, wherein thermally treating oil shale in the presence of a pollutant-containing gas comprises contacting at least a portion of the pollutant-containing gas with at least a portion of the thermally treated oil shale.

11. The method of claim 1, further comprising thermally treating at least one other thermally treatable material in the presence of the pollutant-containing gas, the at least one thermally treatable material selected from the group consisting of coal, a fuel, biomass residuals, wood wastes, municipal solid wastes, and refuse derived fuels.

12. The method of claim 1, further comprising:
producing at least one waste material from the thermal treatment of the oil shale, the at least one waste material comprising at least one of partially thermally treated oil shale and shale sorbent particles;
removing at least a portion of the at least one waste material; and
feeding at least a portion of the at least one waste material to a combustion process.

13. The method of claim 1, further comprising:
removing at least one of at least one sulfur-containing pollutant and at least one halogen-containing pollutant from the pollutant-containing gas.

14. The method of claim 13, wherein removing at least one of at least one sulfur-containing pollutant and at least one halogen-containing pollutant from the pollutant-containing gas comprises exposing the pollutant-containing gas to the thermally treated oil shale at a temperature between about 450° C. and 1150° C.

15. The method of claim 1, further comprising:
removing at least one mercury-containing pollutant from the pollutant-containing gas.

16. The method of claim 15, wherein removing at least one mercury-containing pollutant from the pollutant-containing gas comprises exposing the pollutant-containing gas to the thermally treated oil shale at a temperature of less than or equal to about 200° C.

17. An apparatus for removing at least one pollutant from at least one gas, comprising:
a reactor comprising at least one gas input, at least one gas output, and a thermal treatment zone configured for thermally treating oil shale in the presence of at least one gas fed to the thermal treatment zone to remove at least one pollutant from the at least one gas.

18. The apparatus of claim 17, wherein the reactor is retrofit to an existing combustion process apparatus to accept at least one pollutant-containing gas from the existing combustion process.

19. The apparatus of claim 17, wherein the at least one gas comprises at least one pollutant-containing gas or particulate matter entrained in the at least one pollutant-containing gas.

20. A method of removing at least one pollutant from syngas, comprising:
producing a first syngas from a fuel gasification process and a second syngas, kerogen, and shale sorbent particles from an oil shale gasification process;
maintaining the first syngas and the second syngas at a temperature between about 500° C. and 1000° C. while exposing the first syngas and the second syngas to the kerogen and the shale sorbent particles; and
reducing a temperature of the first syngas and the second syngas to less than or equal to about 200° C. while exposing the first syngas and the second syngas to the kerogen and the shale sorbent particles.

21. The method of claim 20, wherein maintaining the first syngas and the second syngas at a temperature between about 500° C. and 1000° C. while exposing the first syngas and the second syngas to the kerogen and the shale sorbent particles comprises removing at least one of at least one sulfur-containing pollutant and at least one halogen-containing pollutant from the first syngas and the second syngas.

22. The method of claim 20, wherein reducing a temperature of the first syngas and the second syngas to less than or equal to about 200° C. while exposing the first syngas and the second syngas to the kerogen and the shale sorbent particles comprises removing at least one mercury-containing pollutant from the first syngas and the second syngas.

23. The method of claim 20, wherein producing a first syngas from a fuel gasification process comprises producing the first syngas from the gasification of coal, biomass, solid waste or refuse derived fuel, or other bulk fuel.
